(19) United States
(12) Patent Application Publication
(10) Pub. No.: US 2005/0194415 A1
(43) Pub. Date: Sep. 8, 2005

(54) Cotton dispensing system, apparatus and/or method

(76) Inventor: Sasan Danechi, Gentofte (DK)

Correspondence Address: Dahl & Osterloth, LLP, Suite 3405, 555 17th Street, Denver, CO, 80202-3937, US

(21) Appl. No.: 10/795,105

(22) Filed: Mar. 5, 2004

(51) Int. Cl. B26F 3/02; B26F 3/00; B32B 27/12; B32B 27/04; B32B 5/02; B65H 35/10; G07F 11/68; B65H 5/28; B65H 35/00

(52) U.S. Cl. 225/96; 221/70

(57) ABSTRACT

A cotton or like material dispenser containing a roll of cotton or like web material wound about itself with a leading end thereof protruding from the dispenser.

### INTRODUCTION

The present invention relates to the field of cotton or like material products, e.g., cosmetic or medical cotton or like natural and/or synthetic materials, and relates more specifically to the field of dispensers, dispensing systems and/or methods for such cotton or like material products.

### BACKGROUND

Cotton is well known for use in cosmetic applications, as for example in removing facial make up. In such cases, the cotton is held in the hand and applied to the face in order to remove make-up. A cleansing cream or milk is often applied to the cotton before it is applied to the face in order to facilitate the removal of the make up. Similarly, cotton products have been known for use in medical applications as in providing sanitary cleaning or disinfecting and/or absorption materials for bodily fluids, e.g. as used in gauzes, bandages and compresses. Cotton products for such uses have conventionally been dispensed as cotton balls from a bag or jar or as pads from a dispenser in the form of a tubular plastic bag or a plastic tubular housing. Pads are made from cotton web material and may have an advantage over cotton balls in that their shape and sheet like superior mechanical strength may make them more suitable for being held in the hand and applied to the body, as in the wiping of the face when removing facial makeup. The compact surface of cotton pads may help to ensure that the pads do not come apart and do not deposit floss during use. A possible disadvantage of cotton pads may however be the uniform size of the pads in a dispenser. Such a uniform size may not necessarily match the needs of users in all circumstances. Further, as mass produced articles, cotton pad dispensers have to be cheap and simple, and as a result thereof, the procedure of obtaining a single pad can sometimes be cumbersome.

### SUMMARY

The invention described below provides a dispenser, or dispensing system or method for dispensing cotton or like material products. The dispenser may include a housing having a plurality of walls forming an interior chamber and an opening. The interior chamber may contain a cotton or like material web material wound about itself to form a roll. A leading end of the cotton web may then be extended though the opening so that it protrudes from the housing. The interior chamber may also be configured to allow the roll to unwind when the free end of the roll is pulled. Users can then tear off a leading end with a desired length that suits their needs.

In one embodiment, the dispenser housing is provided with a cutting edge to assist in severing a leading end from the cotton or like material web. In some preferred instances, the cutting edge may be disposed at a distance from the opening, so that at least short piece of the leading end may substantially always be protruding from the opening to provide for grabbing with the fingers of a user's hand.

The walls of the housing may form a chute leading from said internal chamber to the opening for guiding the cotton or like material product towards the opening.

The housing may be substantially box shaped for ease of handling, stacking and storing, where a box shaped housing may provide improved stability. The internal chamber can also be substantially box shaped, preferably with the corners extending axially to the roll being rounded off.

In another embodiment, the exterior of the housing may be provided with a plurality of suction cups on a housing wall opposite to a housing wall in which the opening is formed. This allows the housing to be releasably attached to a wall, thus not taking any up any shelf space and allowing a free choice of the height at which the dispenser is placed.

The exterior of the housing can be provided with a plurality suction cups on a bottom housing wall for releasably attaching the dispenser to a surface on which it rests.

When the dispenser is secured to a wall or other surface, it may provide an easier process for severing a piece of cotton web with one hand only.

### BRIEF DESCRIPTION OF THE DRAWINGS

In the following detailed portion of the present description, some embodiments of the invention will be explained in more detail with reference to the exemplary embodiments shown in the drawings, in which:

FIG. 1 is a perspective view of a dispenser filled with a roll of cotton or like material rolled about itself;

FIG. 2 is a perspective view of an empty dispenser;

FIG. 3 is a cross-sectional side view of an empty dispenser; and

FIG. 4 is a bottom view of an empty dispenser.

### DETAILED DESCRIPTION OF THE INVENTION

The present invention is generally directed to dispensing apparatuses, systems and/or methods for dispensing cotton or like material products. Generally, a rolled web of such material products is disposed in a dispenser as described hereinbelow which has an opening through which the products are dispensed. Hereafter, the word cottonish will be used to define the types of material products to be dispensed in accord herewith. Cottonish therefore encompasses cotton as understood in the art, e.g. for cosmetic or medical or other uses; and cottonish also encompasses the like or other combination or substitute material products which can be used herein, as for example cotton blends with other natural or synthetic materials, and/or the non-cotton products made of other natural or synthetic materials (e.g., wools or rayons, inter alia).

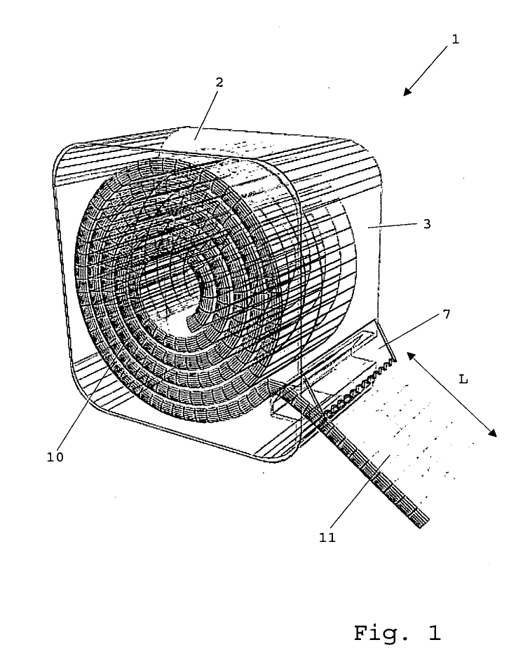

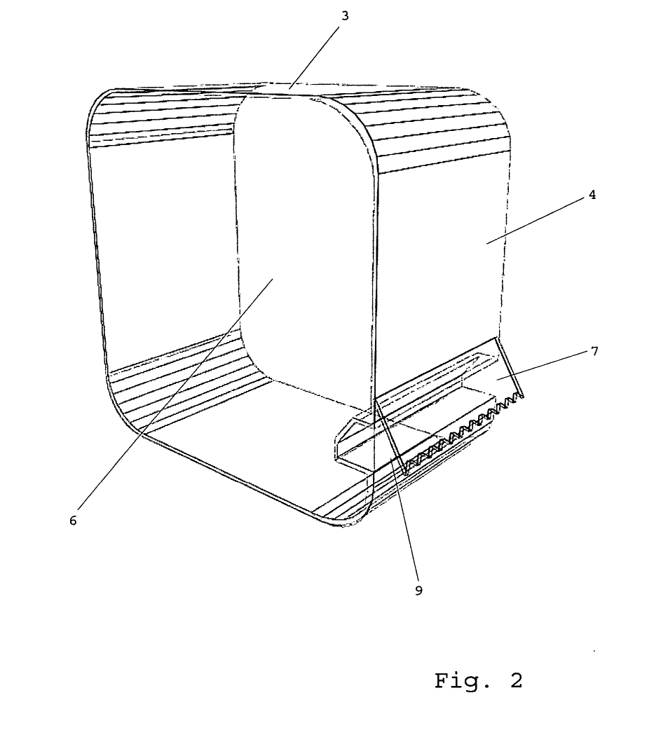

FIG. 1 shows a perspective view of an embodiment of a dispenser for dispensing cotton or cottonish material from a roll 10 of cottonish web material wound about itself. The dispenser comprises a housing 1 of transparent plastic material. Other, materials can be used, also including non-transparent materials. The housing 1 is shown empty in FIGS. 2 to 4. The housing is substantially box-shaped and comprises a top wall 2, a front wall 3, a bottom wall 4, a rear wall 5 and side walls 6. The walls define an inner chamber and an opening 9. The transitions between the walls that extend in axially of the roll 10 are rounded off to facilitate rotation of the roll 10 within the interior chamber. The front wall 3 comprises a chute 9 that guides a free end 11 of the cottonish web material to the opening 9. The free end 11 of the roll 10 extends from the housing 1 through the opening 9. A user grabs the free end 11 and by pulling the free end 11 the cottonish web material is unwound and moves outwardly from the dispenser through the opening 9. The length L of the free end that protrudes outside the housing is freely determined by the user. A toothed cutting edge for facilitating the severing of the web is provided on a lip 7 that protrudes from the front wall here shown at an acute angle. The toothed cutting edge, the chute 8 and the opening 9 are configured to assist in ensuring that the “new” leading end of the cotton web material, formed after a piece of web has been severed, can substantially always be easily grabbed with the fingers. After grabbing the “new” leading end, the user pulls it out to the desired length and severs it at the cutting edge.

In many embodiments, the cottonish material roll is of a substantially continuous web, the separation into pieces of which being accomplished by tearing or like severing usually facilitated by a toothed or like cutting edge 7. Such an arrangement facilitates the user's ability to select the resulting size of the piece of cottonish material actually dispensed for use, i.e., providing potentially desirable flexibility in length selection of the torn off part. However, the practical advantages of ease of cutting or tearing, in particular for a heavy web may not, in some embodiments be as easy as may be desired. Therefore, in some alternative embodiments, the cottonish material web may or could be pre-perforated for simplified tearing/cutting. The resulting dispensed pieces may then be of pre-sized lengths and/or widths. Still further, such perforations may still provide for cottonish pieces variable sizes wherein, the user could select tearing at a first appearing pre-perforation line, or rather at a second such line, or a third or the like, in order to have dispensed a cottonish material product of a desirable, increasingly large size. Even so, the perforation or severing lines in such an example can be relatively closely spaced, so that the user can still have a relatively high flexibility in selection of the desired length of the cottonish product to be dispensed.

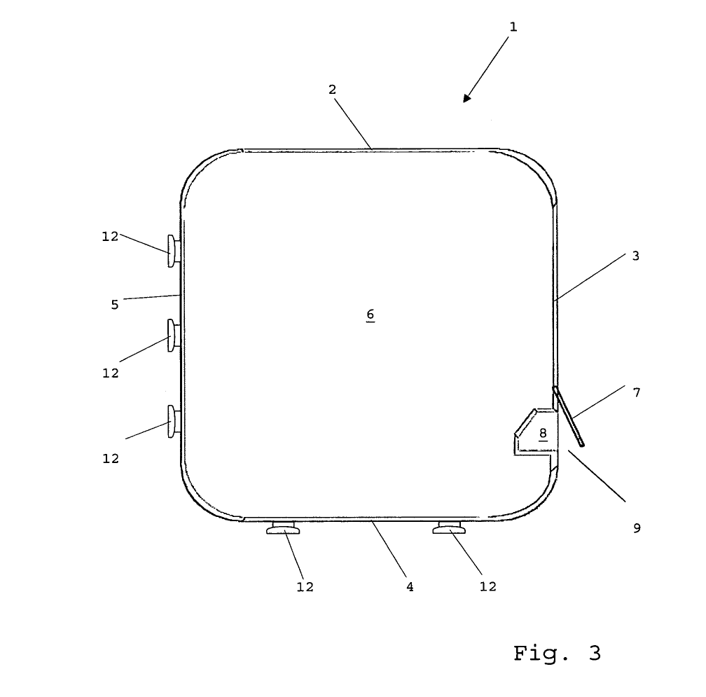

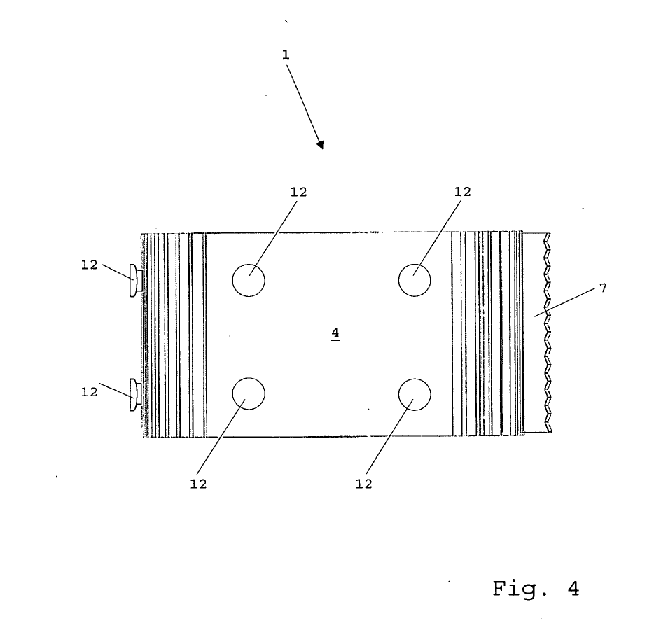

As shown in FIGS. 3 and 4, the rear wall 5 and/or the bottom wall 4 of the dispenser can in some alternative embodiments be provided with a plurality of sucking or suction cups 12. Suction cups 12 on the rear wall 5 allow the dispenser to be secured to a wall in a releasable manner. Suction cups 12 on the bottom wall 4 may alternatively (or additionally) allow the dispenser to be secured to a substantially horizontal surface on which it may thus rest in a releasable manner. One-handed severing of pieces of cotton web may be facilitated when the dispenser is secured with the sucking cups 12. At a sales point the dispenser may be sold with loose, e.g., previously non-attached suction cups that a user attaches as desired either to the bottom wall 4 or to the rear wall 5. Hereto, the base of the suction cups may be provided with snap fit means for fitting in preformed holes in the respective walls of the housing, or the base of the suction cups may be provided with double-sided tape for the attachment of the suction cups to the dispenser.

The outside shape of the housing 1 can be mainly ornamental, on the preferred condition that the housing can either stand or be wall mounted with e.g. suction cups. It is thus possible to have alternative housing shapes which may for example have other means for installation, legs or the like, as e.g., a disk-shaped housing with legs that allow the dispenser to stand (not shown).

The housing 1 can be constructed so that it can be opened for refilling the internal chamber with a new roll 10 of cotton web material. This is preferably achieved by a hinged top wall 2 that can open like a door to the internal chamber.

A suitable, exemplary cotton material which may be used herein/herewith, e.g., a chemically laid cotton web material for forming rolls is commercially available from the Georgia-Pacific Corporation, Atlanta, Ga. This particular cotton web material is conventionally used for producing cotton pads. An exemplary process of preparing such a cotton web is in its main features as follows. After the cotton flock is opened, the fibers may be mixed and homogenized. Then the carding operation may take place, along with the fiber randomization process, which may confer softness and strength to the cotton web and reduce knots to a minimum. Through a treatment with water under high pressure (water jet), the cotton fibers may be crossed and tied. Similar stable webs can be produced by chemical laying or spun laying.

The cotton web may in many embodiments have a density ranging from 140 g/m² to 380 g/m². The thickness of the web may in many non-limitative embodiments range from 5 mm to 20 mm. The width of the web is in many cases preferably about 6 cm for facial application/cleansing and about 2 cm for removing nail polish. The width may though vary significantly from these preferred values and very often any width between 1 and 12 cm could be used, although smaller and larger sizes are possible. A width of 10 to 12 cm is particularly useful for many body treatments.

As mentioned, the cotton or like material products hereof can be used for cosmetic situations and/or in medical applications such as in providing sanitary cleaning and/or absorption materials for bodily fluids, making gauzes, bandages, or compresses, baby napkins and sanitary towels, and the like. Additionally, the cotton or like materials hereof may be used in any of many other areas of traditional cotton or like fiber usage.

Also as introduced above, the cottonish material may be cotton or a mixture or solely a cotton substitute, usually of an absorbent nature, may be used within and/or as part of the present invention. Such a substitute can be produced from wool, jute/jute wastes, hemp or other natural fibrous and/or absorbent goods, and/or by or with synthetic materials, e.g., acrylics, polyesters, rayon or dacron or other such materials. Also, substitutes may be made by blending of any of these substances with each other, as for example, combining discrete natural products; discrete synthetics and/or naturals with synthetics as cotton with rayon, inter alia. The cotton substitute may in many preferred instances be absorbent and as with the cotton products discussed above can be used for cosmetic situations, e.g., facial application and/or cleaning and/or for removing nail polish; and/or for medical applications such as in providing sanitary cleaning and/or absorption materials for bodily fluids, making gauzes, bandages, compresses, baby napkins and/or sanitary towels, etc.; or in other areas of cotton usage.

While the preferred embodiments of the device have been described in reference to the environment in which they were developed, they are merely illustrative of the principles of the invention. Other embodiments and configurations may be devised without departing from spirit of the invention and the scope of the appended claims.

1. A dispenser for dispensing a cottonish material comprising:
a housing having a plurality of walls forming an interior chamber and an opening,
said interior chamber containing cottonish web material wound about itself to form a roll with a leading end of said cottonish web extending through said opening,
said interior chamber being configured to allow said roll to unwind when the free end of said roll is pulled.

2. A dispenser according to claim 1, wherein said housing is provided with a cutting edge to assist in severing a leading end from said roll of cottonish web material; thereby providing a dispensed piece of cottonish material.

3. A dispenser according to claim 2, wherein the cutting edge is disposed at a distance from said opening.

4. A dispenser according to claim 1, wherein the walls of said housing form a chute leading from said internal chamber to said opening.

5. A dispenser according to claim 1, wherein the housing is substantially box-shaped.

6. A dispenser according to claim 1, wherein said internal chamber is substantially box-shaped.

7. A dispenser according to claim 1, wherein the exterior of the housing is provided with one or more suction cups on a housing wall opposite to a housing wall in which said opening is formed.

8. A dispenser according to claim 1, wherein the exterior of the housing is provided with one or more suction cups on a bottom housing wall.

9. A dispenser according to claim 1, wherein the internal chamber is refillable with a new roll of cottonish web material; whereby the housing has a hinged top wall which is adapted to be opened and thereby provide access to the internal chamber.

10. A dispenser according to claim 1, wherein said cottonish web material has a density of in a range between 140 g/m² to 380 g/m² and a thickness of 5 mm to 20 mm.

11. A dispenser according to claim 1, wherein the cottonish web material is selected from the group consisting of: cotton, a cotton blend, cotton-like material, wool, jute, hemp, synthetic material, acrylic, polyester, rayon, and dacron.

12. A dispenser according to claim 1, wherein the cottonish web material is pre-perforated to provide for dispensing of pre-sized pieces of cottonish material.

13. A system for dispensing a cottonish material, comprising:
a dispenser formed from a housing having a plurality of walls defining an interior chamber and an opening;
a cottonish web material wound about itself to form a roll, said roll being disposed in said interior chamber of said dispenser housing, and said roll having a leading end of which being disposed to extend through said opening;
whereby, said interior chamber of said dispenser housing is adapted to allow said roll to unwind when the free end of said roll is pulled through said opening to thereby dispense said cottonish material.

14. A method for dispensing a cottonish material, comprising:
disposing a roll of a cottonish web material in a dispenser which has been formed from a housing having a plurality of walls defining an interior chamber and an opening, whereby the roll of cottonish material has a leading of which disposed to extend outwardly through said opening;
pulling the free end of said roll of cottonish web material outwardly from said opening in said housing to dispense said cottonish material from said dispenser;
whereby, said interior chamber of said dispenser housing is adapted to allow said roll to unwind when is pulled.
